(19) United States
(12) Patent Application Publication
(10) Pub. No.: US 2006/0130807 A1
(43) Pub. Date: Jun. 22, 2006

(54) Control apparatus for an internal combustion engine

(76) Inventor: Manabu Miura, Kanagawa (JP)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/314,276

(22) Filed: Dec. 21, 2005

(30) Foreign Application Priority Data
Dec. 22, 2004 (JP) 2004-370959

(51) Int. Cl. F02D 41/30

(52) U.S. Cl. 123/339.14; 123/339.16; 123/339.24

(57) ABSTRACT

To allow control of the revolution with good response during idling operation even if the air excess coefficient is reduced, thereby reducing the isovolumetric level in a diesel engine, the isovolumetric level CVOL is estimated based on at least one of air excess coefficient, fuel ignition timing, and pressure end temperature inside a cylinder. The engine load FMOT is estimated based on at least one of intake air pressure, EGR rate, air excess coefficient, water temperature, and auxiliary load. The idle injection rate is calculated from the isovolumetric level CVOL and engine load FMOT.

### RELATED APPLICATIONS

The disclosure of Japanese Patent Application No. 2004-370959, filed Dec. 22, 2004, including the specification, drawings and claims, is incorporated herein by reference in its entirety.

### FIELD

Described herein is a control apparatus for an internal combustion engine, and in particular, a control apparatus for controlling an internal combustion engine during idling operation.

### BACKGROUND

In an internal combustion engine, in particular a diesel engine, feedback control of the fuel injection rate is carried out so that the actual revolution rate of the engine matches a target revolution rate during idling operation.

However, the period of combustion becomes longer when an air excess coefficient (λ) is lower than that in normal lean operation of the diesel engine, and therefore the isovolumetric level is significantly reduced. Consequently, it is difficult to carry out revolution control by feedback control of the rate of fuel injection. When the combustion period also becomes longer because of delay of fuel ignition timing, or due to the reduction of the pressure end temperature in the cylinder, the isovolumetric level is significantly reduced, and therefore it is difficult to carry out revolution control by feedback control of the rate of fuel injection.

The “isovolumetric level” means a ratio of the actually demonstrated heat efficiency, when the heat efficiency is one hundred percent (100%) in isovolumetric combustion (virtual combustion that is effected at once without changing capacity at the top dead point when the compressed pressure is at peak).

When the EGR rate is reduced at a constant air excess coefficient, the collector pressure is reduced and the intake air resistance increases. In the event that the engine load increases due to an increase in such intake air resistance or there is an increase in friction resistance, it is difficult to carry out revolution control with feedback control of the rate of fuel injection.

### SUMMARY

The present control apparatus for an internal combustion engine is capable of controlling revolution rate with good response during idling operation, wherein the isovolumetric level and engine load during idling operation are individually estimated and the rate of fuel injection during idling operation is calculated therefrom.

In addition, revolution control during idling operation can be carried out with a good response by increasing the rate of the idling injection in advance in a feed-forward manner when the isovolumetric level is reduced or the engine load is increased during idling operation.

### BRIEF DESCRIPTION OF THE DRAWINGS

For a more complete understanding of the present control apparatus for an internal combustion engine, reference is now made to the following description taken in conjunction with the accompanying drawings, in which:

FIG. 1 is a system diagram of an embodiment of an engine;

FIGS. 2A and 2B are graphs illustrating the relationship between combustion period, and the relationship between torque and combustion period, respectively, illustrating a problem when the air excess coefficient is decreased;

FIG. 3 is a graph illustrating a transition of an internal cylinder waveform along with a change in the air excess coefficient;

FIG. 4 is a graph illustrating a transition of an internal cylinder waveform along with a change in ignition timing;

FIG. 5 is a graph illustrating a transition of an internal cylinder waveform along with a change in pressure end temperature;

FIGS. 6A and 6B are graphs illustrating the relationship between collector pressure and EGR rate, and the relationship between intake air resistance and collector pressure, illustrating a problem when the EGR rate is decreased;

FIG. 7 is a flowchart illustrating control of the idle injection rate;

FIGS. 8A, 8B, and 8C are graphs illustrating the relationship between the isovolumetric level and the air excess coefficient, the ignition timing and the pressure end temperature, respectively;

FIGS. 9A, 9B, 9C, and 9D are graphs illustrating the relationship between the pressure end temperature and the intake air pressure, the EGR rate, the new air temperature and the air excess coefficient, respectively;

FIGS. 10A, 10B, and 10C are graphs illustrating the engine load and the relationship between the intake air pressure, the EGR rate, the air excess coefficient, the revolution and the water temperature, respectively;

FIG. 11 is a graph illustrating the relationship between the isovolumetric level and the correction coefficient; and

FIG. 12 is a graph illustrating the correlation between the engine load and the correction coefficient.

### DETAILED DESCRIPTION OF THE ILLUSTRATED EMBODIMENTS

The following description refers to embodiments of the present control apparatus for an internal combustion engine. While the claims are not limited to such embodiments, an appreciation of various aspects of the control apparatus is best gained through a discussion of various examples thereof.

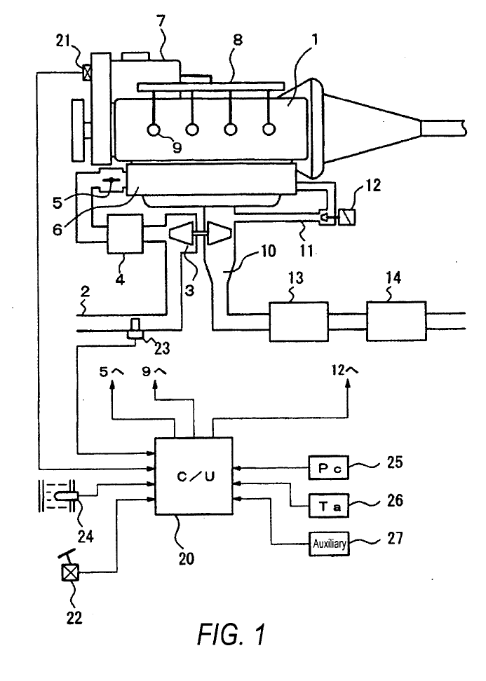

FIG. 1 is a system diagram showing an embodiment of the present internal combustion engine (a diesel engine in this case).

An intake air compressor of a supercharger (turbocharger) 3 is provided in an inlet path 2 of the diesel engine 1. Intake air is supercharged by the intake air compressor, and cooled by an intercooler 4 from whence it flows into the combustion chambers of each cylinder via the collector 6 after passing through an inlet throttle valve 5. Using a common rail-type fuel injection device, the fuel is pressurized by a high-pressure fuel pump 7, sent to a common rail 8, and directly injected inside the combustion chamber from a fuel injection valve 9 of each cylinder. Air flows into the combustion chamber, the injected fuel is ignited by compression, and the exhaust flows out to an exhaust path 10.

A portion of the exhaust that flows out to the exhaust path 10 flows back to the inlet side (inside the collector 6) by an EGR device, that is, an EGR path 11, via an EGR valve 12. The remainder of the exhaust passes through and drives the exhaust turbine of the supercharger 3.

In addition, a NOₓ trap catalyzer 13, comprising a three-way catalyst to which NOₓ trapping material is added, is provided downstream of the exhaust turbine in the exhaust path 10 in order to purify the exhaust. The catalyzer 13 is capable of trapping NOₓ in the exhaust when the air-fuel ratio of the exhaust is lean and it is capable of eliminating and purifying the trapped NOₓ when the air-fuel ratio of the exhaust is stoichiometric or rich.

In addition, a diesel particulate filter (DPF) 14 that collects PM (particulate matter) is provided downstream of the NOₓ trap catalyzer 13.

In order to control the engine 1, signals are transmitted to a control unit 20 from: a revolution sensor 21 that detects the engine revolution rate Ne; an axle aperture sensor 22 that detects axle aperture APO (open degree); an aero flowmeter 23 that detects the intake air rate Qa; a water temperature sensor 24 that detects the temperature of the engine cooling water or coolant Tw; an intake air pressure sensor 25 that detects the intake air pressure (intake air pressure inside the collector 6) Pc; an intake air temperature sensor 26 that detects the intake air temperature (new air temperature) Ta, and an auxiliary load switch 27.

Based on the above-mentioned input signals, the control unit 20 transmits a fuel injection command signal to the fuel injection valve 9 to control the rate of fuel injection and the timing of the fuel injection by the fuel injection valve 9. The control unit also transmits an inlet throttle aperture command signal to the inlet throttle valve 5, and an EGR valve aperture command signal to the EGR valve 12, etc.

In general, during idling operation a diesel engine carries out feedback control with respect to the rate of fuel injection so that the actual engine revolution rate matches a target idle revolution rate.

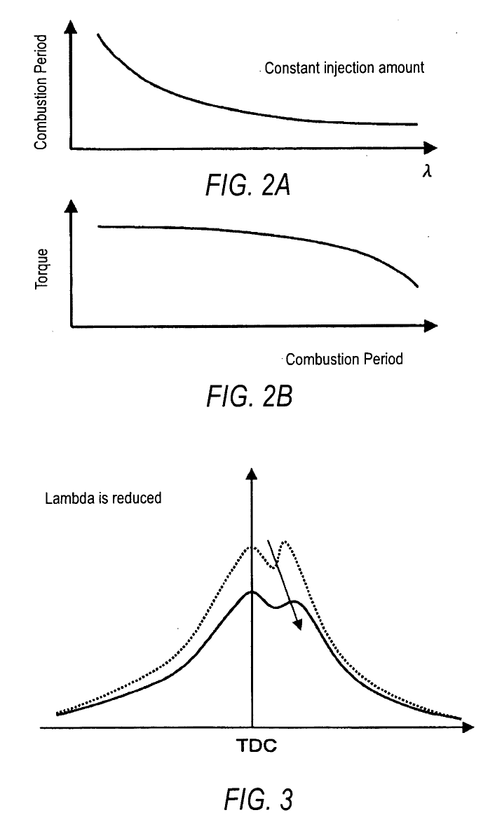

However, when an air excess coefficient (λ) is lower than the normal lean range for diesel engines, as shown in FIGS. 2A and 2B, as the λ decreases, the combustion period becomes longer, thereby significantly reducing the isovolumetric level. In other words, the longer the combustion period, the more torque is reduced. Therefore, it is difficult to control the revolution rate by feedback control of the rate of fuel injection.

In other words, when the injection rate is constant and the air excess coefficient is low, compression pressure does not increase and cylinder temperature is reduced due to reduction of the amount of air, and therefore the combustion period becomes longer because it is difficult to ignite and combust, so that torque is decreased. With feedback control, since the rate of fuel injection is increased after torque is decreased, the torque reduction cannot be controlled, or hunching is generated. The waveform of the internal cylinder pressure is shown in FIG. 3 (dotted line→solid line) in the case in which λ is reduced.

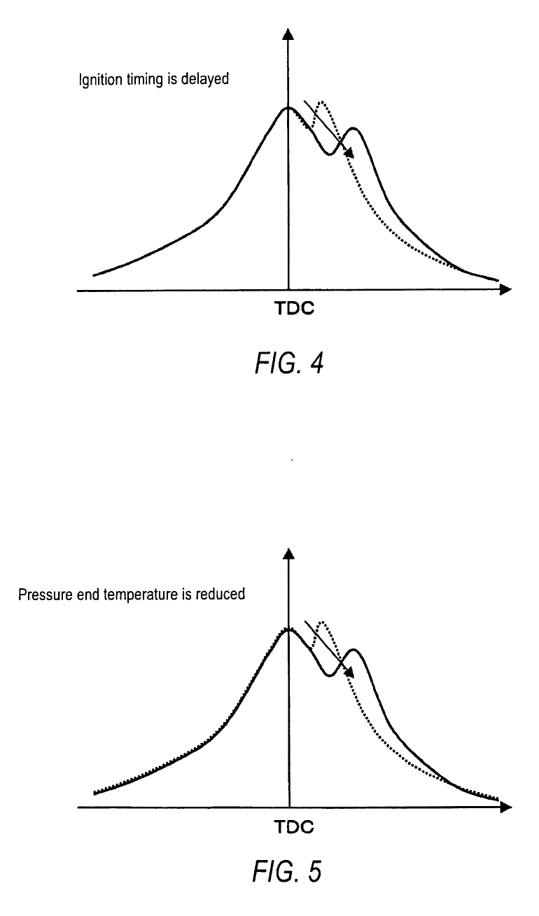

Since the isovolumetric level is significantly reduced when the combustion period becomes longer due to delayed fuel ignition timing, or when the combustion period becomes longer due to reduced pressure end temperature, it is difficult to carry out revolution control with feedback control of the rate of fuel injection. The waveform of the internal cylinder pressure is shown in FIG. 4, when ignition timing is delayed, and the waveform of the internal cylinder pressure is shown in FIG. 5 when pressure end temperature is reduced.

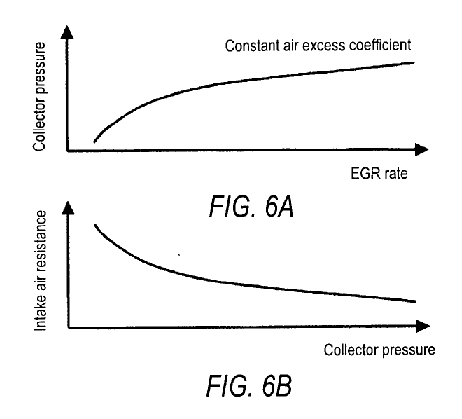

As shown in FIGS. 6A and 6B, when an air excess coefficient is constant and the EGR rate is decreased, the collector pressure (intake air pressure) decreases and the intake air resistance increases. When the engine load is increased due to such an increase in intake air resistance, it is also difficult to carry out revolution control with feedback control of the rate of the fuel injection. It is the same as that in the case of an increase of engine load due to an increase in friction resistance.

Therefore, the isovolumetric level and engine load during idling operation are separately estimated, based on which estimates the rate of the fuel injection during idling operation is calculated and controlled in a feed-forward manner.

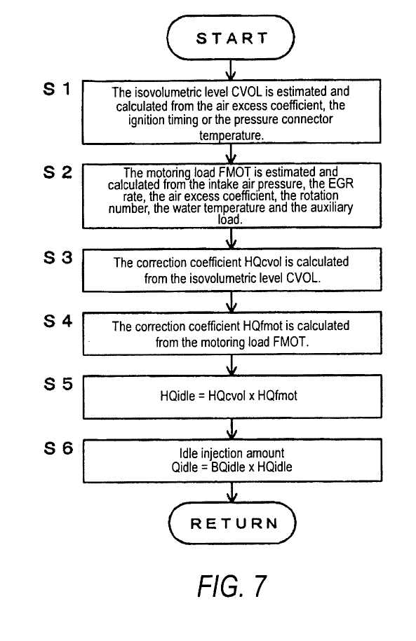

FIG. 7 is a flowchart of the fuel injection rate (idle injection rate) control during idling operation as executed by the control unit 20. This process is executed time-wise or revolution-wise synchronously during the idling operation.

In step S1, the isovolumetric level CVOL is estimated and calculated from the air excess coefficient (λ), the fuel ignition timing, the pressure end temperature inside the cylinder, or a combination thereof.

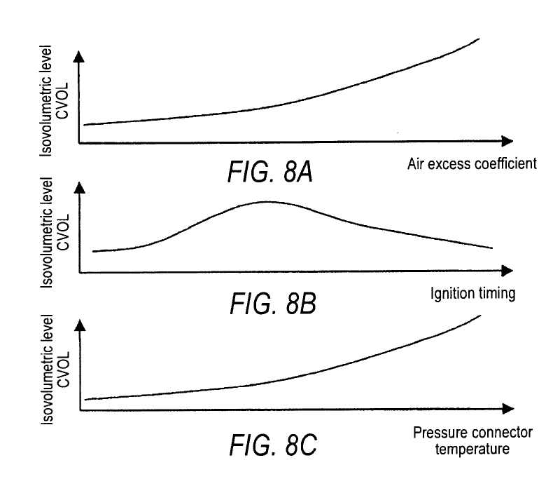

The target air excess coefficient is used as the air excess coefficient, and the isovolumetric level CVOL corresponding to the air excess coefficient is calculated using the air excess coefficient-isovolumetric level table in FIG. 8A. Here, it is configured so that the isovolumetric level CVOL becomes larger as the air excess coefficient increases, and the isovolumetric level CVOL becomes smaller as the air excess coefficient decreases.

The isovolumetric level CVOL corresponding to the ignition timing is calculated from the ignition timing/isovolumetric level table in FIG. 8B. Here it is configured so that the isovolumetric level reaches its largest point when the ignition timing is appropriate, and the isovolumetric level decreases as the spark is advanced or delayed.

The pressure end temperature depends on the intake air pressure (collector pressure), the EGR rate, the new air temperature and the air excess coefficient, and therefore it is estimated from at least one of the above.

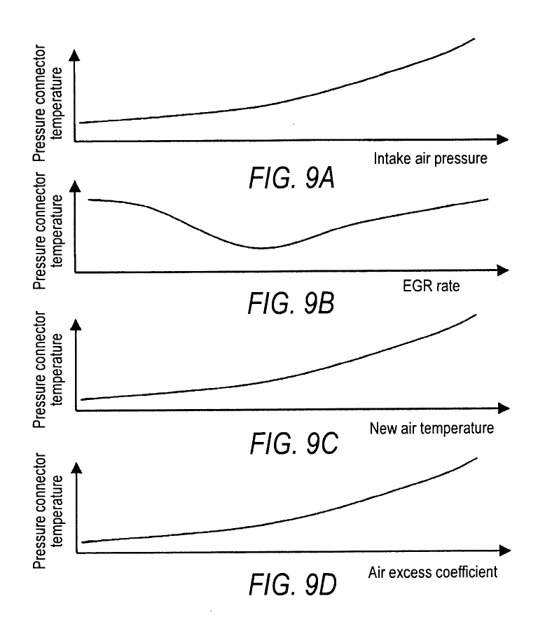

FIG. 9A shows the intake air pressure-pressure end temperature table. The higher the intake air pressure, the higher the pressure end temperature becomes.

FIG. 9B shows the EGR rate/pressure end temperature table. When the EGR rate takes a certain value, the pressure end temperature reaches its lowest point, and as the EGR rate is increased or decreased from that point, the pressure end temperature becomes higher.

FIG. 9C shows the new air temperature/pressure end temperature table. The higher the new air temperature, the higher the pressure end temperature becomes.

FIG. 9D shows the air excess coefficient/pressure end temperature table. The higher the air excess coefficient, the higher the pressure end temperature becomes.

The pressure end temperature can be estimated from at least one of the intake air pressure (collector pressure), the EGR rate, the new air temperature, and the air excess coefficient. However, the greater the number of inputs, the greater will be the precision of the estimation.

Once the pressure end temperature is estimated, the isovolumetric level CVOL corresponding to the pressure end temperature is calculated from the pressure end temperature/isovolumetric level table in FIG. 8C. Here, it is configured so that the isovolumetric level CVOL increases along with an increase in the pressure end temperature, and the isovolumetric level CVOL decreases along with a decrease in the pressure end temperature.

In step S2, the engine load (intake air resistance and friction resistance) FMOT is estimated and calculated from at least one of the intake air pressure, the EGR rate, the air excess coefficient, the engine revolution, the water temperature, and the auxiliary load.

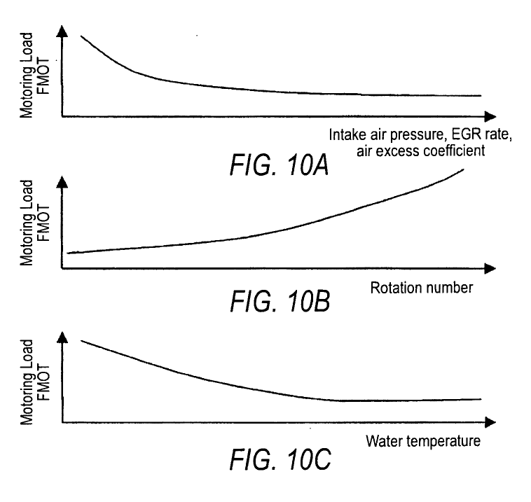

FIG. 10A is a table illustrating the relationships between the intake air pressure, the EGR rate and the air excess coefficient, and the engine load FMOT. The intake air resistance decreases along with an increase in the intake air pressure, and consequently, the engine load FMOT decreases. In addition, the intake air resistance decreases when the EGR rate becomes high, and consequently, the engine load FMOT decreases. Furthermore, the intake air resistance decreases when the air excess coefficient becomes high, and consequently, the engine load FMOT decreases.

FIG. 10B shows the engine revolution rate/engine load table. The friction resistance increases along with an increase in the engine revolution rate, and consequently, the engine load FMOT increases.

FIG. 10C shows a water temperature/engine load table. The friction resistance decreases along with an increase in water temperature, and consequently the engine load FMOT decreases.

Regarding the auxiliary load, the engine load FMOT increases along with the increase in the total value of the auxiliary load. In this case, the greater the number of parameters, the greater the precision of the estimation will be.

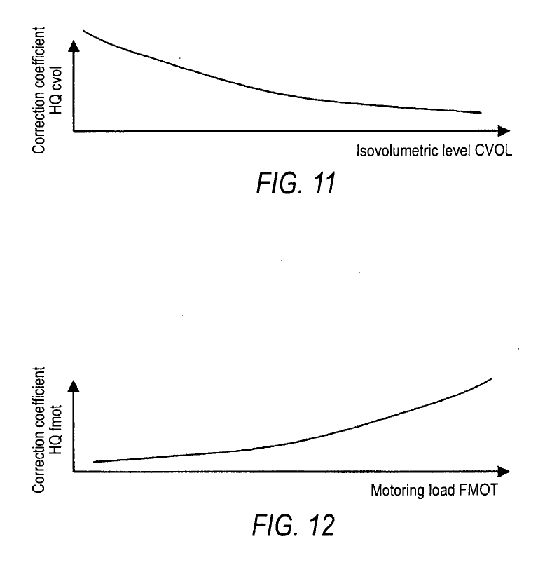

In step S3, the correction coefficient Qcvol corresponding to the idle injection rate is calculated from the isovolumetric level CVOL found in step S1 by referring to the CVOL-HQcvol table of FIG. 11. Here, the correction coefficient Qvol is reduced to make an adjustment by decreasing the idle injection rate as the isovolumetric level CVOL increases, and the correction coefficient Qvol is increased to make an adjustment by increasing the idle injection rate as the isovolumetric level CVOL decreases.

In step S4, the correction coefficient Qfmot corresponding to the idle injection rate is calculated from engine load FMOT obtained in step S2 by referring to the FMOT-HQfmot table of FIG. 12. Here the correction coefficient Qfmot is increased to make an adjustment by increasing the idle injection rate as the engine load FMOT increases.

In step S5, the final correction coefficient HQindle (=HQcvol×Hqfmot) corresponding to the idle injection rate is calculated by multiplying the correction coefficient HQcvol obtained in step S3 and the correction coefficient HQfmot obtained in step S4.

In step S6, the idle injection rate Qidle (=BQidle×Hqidle) is calculated and control is exercised by multiplying the basic value of the idle injection rate BQidle, which is established based on the axle aperture APO and the engine revolution Ne, with the correction coefficient HQidle obtained in step S5.

According to the present embodiment, there are provided means for estimating the isovolumetric level CVOL during idling operation (S1), means for estimating the engine load FMOT during idling operation (S2), and means for calculating the fuel injection rate during idling operation from the isovolumetric level CVOL and the engine load FMOT (steps S3 to S6), and therefore control of the revolution rate during idling operation can be carried out with good response by increasing the idle injection rate Qidle in a feed-forward manner when the isovolumetric level CVOL decreases or the engine load FMOT increases.

In addition, according to the present embodiment, the isovolumetric level CVOL can be easily and accurately estimated based on at least one of the air excess coefficient, the fuel ignition timing, and the pressure end temperature inside the cylinder.

Furthermore, according to the present embodiment, the pressure end temperature can be easily and accurately estimated based on at least one of the intake air pressure, the EGR rate, the new air temperature, and the air excess coefficient.

Still further, according to the present embodiment, the engine load FMOT can be easily and accurately estimated based on at least one of the intake air resistance and the friction resistance.

Further yet, according to the present embodiment, the intake air resistance can be easily and accurately estimated based on at least one of the intake air pressure, the EGR rate, and the air excess coefficient.

Moreover, according to the present embodiment, the friction resistance can be easily and accurately estimated based on at least one of the engine cooling water temperature and the auxiliary load.

While the present control apparatus has been described in connection with an embodiment thereof, this is by way of illustration and not of limitation, and the appended claims should be construed as broadly as the prior art will permit.

What is claimed is:

1. A control apparatus for an internal combustion engine, comprising:
a unit for estimating an isovolumetric level during idling;
a unit for estimating an engine load during idling; and
a unit that selectively calculates the rate of fuel injection during idling operation based on the isovolumetric level and engine load.

2. The control apparatus for an internal combustion engine according to claim 1, wherein the isovolumetric level is estimated using at least one of air excess coefficient, timing of fuel ignition, and pressure end temperature in a cylinder.

3. The control apparatus for an internal combustion engine according to claim 2, wherein pressure end temperature is estimated using at least one of inlet pressure, EGR rate, new air temperature, and air excess coefficient.

4. The control apparatus for an internal combustion engine according to any one of claims 1 to 3, wherein engine load is estimated using at least one of inlet resistance and friction resistance.

5. The control apparatus for an internal combustion engine according to claim 4, wherein inlet resistance is estimated using at least one of inlet pressure, EGR rate and air excess coefficient.

6. The control apparatus for an internal combustion engine according to claim 4, wherein friction resistance is estimated using at least one of engine cooling water temperature and auxiliary load.

7. The control apparatus for an internal combustion engine according to claim 5, wherein friction resistance is estimated using at least one of engine cooling water temperature and auxiliary load.

8. A control apparatus for an internal combustion engine, comprising:
means for estimating an isovolumetric level during idling;
means for estimating an engine load during idling; and
means for selectively calculating the rate of fuel injection during idling operation based on the isovolumetric level and engine load.
